(19) United States
(12) Patent Application Publication
(10) Pub. No.: US 2016/0120192 A1
(43) Pub. Date: May 5, 2016

(54) GLUTEN ENRICHMENT OF FOODS FOR IRRITABLE BOWEL SYNDROME SUFFERERS

(71) Applicants: Kerith Rae DUNCANSON, Forster (AU); Mark Geoffrey WHITEHOUSE, Forster (AU)

(72) Inventors: Kerith Rae Duncanson, Forster (AU); Geoffrey Mark Whitehouse, Forster (AU)

(21) Appl. No.: 14/889,867

(22) PCT Filed: May 7, 2014
(86) PCT No.: PCT/AU2014/050030

§ 371 Date: Nov. 9, 2015

(30) Foreign Application Priority Data
May 9, 2013 (AU) 2013901642

(51) Int. Cl. A21D 13/06; A21D 2/26; A21D 2/36; A21D 13/04

(52) U.S. Cl. CPC A21D 13/064; A21D 13/04; A21D 2/265; A21D 2/266; A21D 2/36; A23L 1/16; A23V 2002/00

(57) ABSTRACT

A dry flour based product is disclosed which is made from ground and whole grains that are low in fructans, to be enriched with gluten (gluten flour or its substrates gliadin and glutenin). The gluten can range from 5.0 grams per 100 gram to 35.0 grams per 100 grams. The ground grains that are included are those traditionally marketed as gluten free and include, either singly or in combination, rice flour, potato flour, buckwheat flour, corn flour or other low fructans flour products. Added whole grains cart include quinoa, oats and seeds. The addition of gluten (as a flour) allows the resulting dough products made from the flour mix to act more like wheat based flours during cooking or baking, than currently available gluten free flours. The resulting low fructans product; is a medicament useful in the management of irritable bowel syndrome, as individuals are thought to react to the fructans (carbohydrate) component of wheat, barley, and rye, not the protein gluten content. Therefore a product than contains gluten to provide elasticity and crustiness is more, palatable than a product devoid of gluten, and not consumed by choice, but only consumed because it is also low in fructans.

### FIELD OF THE INVENTION

The present invention relates to foodstuffs and, in particular, to food able to be consumed without adverse symptoms by Irritable Bowel Syndrome (IBS) sufferers. The invention also relates to gluten enriched low fructan flour, dough, and cooked products made from such flour or dough. In addition, the invention relates to a method for producing the dough from the flour products by the addition of liquids.

### BACKGROUND OF THE INVENTION

Gluten is a protein composite that gives elasticity to dough helping it rise and maintain or keep its shape when baked, and provides the final product with a crunchy, chewy texture.

Gluten enriched flour/dough products are known. Gluten is a composite of glutenin and prolamin, which composite is conjoined with starch in the endosperm of wheat, rye, barley, spelt and related grain species.

Wheat gluten forms when gliadin (wheat prolamin) molecules form a network attached to gliadin. This cross linking contributes viscosity (thickness) and extensibility to the dough mix. If this dough mix is leavened with yeast. fermentation produces carbon dioxide bubbles, which, trapped by the gluten network, cause the dough to rise. Baking coagulates the gluten, which, along with starch, stabilizes the shape of the final product. It is common to add extra gluten to bread dough for additional elasticity and leavening.

The development of gluten (i.e., enhancing its elasticity) affects the texture of the baked goods. Gluten's elasticity is proportional to its content of glutenins. More refining of the gluten leads to chewier baked products such as pizza and bagels, while less refining yields tender or more, friable) baked goods such as pastry products.

Gluten enhanced flour can be produced by washing starch out of conventional flour until the remaining protein content of the flour is between 70% and 90%. The washing reduces the carbohydrate, or starch, content of the flour and the more washing that occurs, the lower the carbohydrate content and the higher the protein content in percentage terms. The protein content cannot be measured directly, so an estimate determined by calculation is used. The amount of nitrogen in the washed flour is measured and then multiplied by a factor in the range of 5.7-6.2 in order to approximate the actual protein content. So if the flour were highly extracted, and a multiplication factor of 6.2 had been used, this would result in a calculated protein content close to 90%. However, if the flour were less “pure” and a calculation factor of 5.7 was used, the estimated protein content would be close to 70% instead.

A gluten-free diet is the evidence-based treatment for various medical conditions including Coeliac Disease (also spelt Celiac Disease), and those individuals with dermatitis herpetiformis. The prescribed gluten free diet is a general diet with substantially complete elimination of all foods prepared using flour made from wheat, rye, or barley.

A diet low in gluten has also been the usual treatment for Non Coeliac Gluten Sensitivity (NCGS). which is colloquially known as so called “gluten intolerance”. But current scientific literature suggests this might not be a discrete entity or that this entity might be confounded by FODMAP restriction, and that gluten might not be a specific trigger of functional gut symptoms once dietary FODMAPs are reduced (Biesiekierski et al, Gastroenterology 2013;145:320-328 published in August 2013).

Research conducted at Monash University, Melbourne Australia identified that a high proportion of patients reported alleviation of gastro-intestinal symptoms with elimination of wheat, barley, and rye in the absence of Coeliac disease, but with a generic diagnosis of Irritable Bowel Syndrome. This finding was further investigated, culminating in the coining of the term FODMAPs. FODMAPs is an acronym referring to Fermentable Oligosaccharides, Disaccharides, Monosaccharides and Polyols. Another substantially equivalent, but more generic, term is FOLFAP, an acronym for Fructose, Oligosaccaride, Lactose, Fructans and Polyols. FODMAPs and FOLFAPs are a collection of carbohydrate derived molecules found in food and can be poorly absorbed by some people. When the molecules are poorly absorbed in the small intestine of the digestive tract, these molecules continue through the digestive tract to the large intestine, where they act as a food source for the bacteria that live there normally. The bacteria then digest/ferment these FODMAPs and FOLFAPs. This bacterial action can cause the symptoms of Irritable Bowel Syndrome (IBS). The symptoms of Irritable Bowel Syndrome include abdominal bloating and distension, excess wind (flatulence), abdominal pain, nausea, changes in bowel habits (diarrhoea, constipation, or a combination of both), and other gastro-intestinal symptoms.

In addition, fructose and polyols can affect the Osmotic balance of the digestive system. This results in additional liquid being drawn into the bowel with diarrhoea being the consequence.

Fructans are poorly digested carbohydrates commonly found in the onion and garlic families and in wheat, barley and rye. Part of the usual treatment of IBS is to reduce fructans from the diet by eliminating or reducing wheat, barley and rye. Gluten free breads, cereals, grains and pasta are used to replace conventional wheat, barley and rye products, as these gluten free foodstuffs are the most available foodstuffs having low concentrations of wheaten and/or barley and/or rye constituents in the commercially available food system. That is, IBS sufferers are able to conveniently buy these prepared foodstuffs in normal shops and supermarkets.

However, due to the absence of gluten in these gluten-free commercially available products, the texture and elasticity of gluten-free breads and pasta, for example, are inferior to gluten containing breads and pasta.

### GENESIS OF THE INVENTION

The genesis of the present invention is a desire to provide a medicament to alleviate the symptoms of IBS sufferers and, in particular to produce medicament containing foodstuffs having textures and elasticity approaching those of gluten containing breads and pasta but which are suitable for persons wishing to undertake a low FODMAP or FOLFAP diet which necessarily means a low fructan intake.

### SUMMARY OF THE INVENTION

In accordance with a first aspect of the present invention there is disclosed the use of gluten in the manufacture of a medicament for the treatment of irritable bowel syndrome.

In accordance with a second aspect of the present invention there is disclosed a medicament for treating irritable bowel syndrome, said medicament comprising a gluten content of between 5% and 35% by weight in a low fructan flour based product.

In accordance with a third aspect present invention there is disclosed a method of treating the symptoms of irritable bowel syndrome comprising the steps of substantially simultaneously reducing the intake of fructans or FODMAPS or FOLFAPs, and increasing the intake of gluten.

In accordance with a fourth aspect of the present invention there is disclosed a method of treating, alleviating, or preventing, symptoms associated with irritable bowel syndrome in a person in need of treatment therefor, the method comprising the steps of providing food to said person wherein said food includes flour comprising a mixture of one or more low fructan flours and gluten or gluten flour such that said flour mixture substantially excludes wheat flour, barley flour and rye flour.

In accordance with a fifth aspect of the present invention there is disclosed a method of improving the palatability of a low fructan food product without increasing the fructan content of said low fructan food product, said method comprising the step of increasing the gluten content of said product.

In accordance with the sixth aspect of the present invention there is disclosed a flour comprising a mixture of one or more low fructan flours, and gluten or gluten flour wherein said flour mixture substantially excludes wheat flour, barley flour, and rye flour, said flour mixture being used in the manufacture of a medicament for use in treating, alleviating, or preventing, symptoms associated with irritable bowel syndrome. A dough made from the abovementioned flour is also disclosed, as are various baked or otherwise cooked products made from the dough.

### DETAILED DESCRIPTION

Preferred embodiments of the invention will now be described, by way of example only. The present inventors have recognised that gluten itself is a protein. and therefore gluten flour contains only minimal residual fructans. Accordingly. if a low fructan grain flour is combined with gluten (or gluten flour) to make a dough for bread and pasta, the inclusion of gluten (or gluten flour) allows for a potentially more palatable and texturally satisfying baked, or otherwise cooked, carbohydrate product which is suitable for low FODMAP and FOLFAP diets.

A dry flour based product is made from ground grains and, if desired, whole grains also, that are low in fructans. The flour is enriched with gluten (gluten flour or its substrates gliadin and glutenin). The gluten content can range from 5.0 grams per 100 gram to 35.0 grams per 100 grams (i.e. 5%-35% by weight and preferably between approximately 10% and approximately 30% by weight). The ground grains that are included are those traditionally marketed as gluten free and include, either singly or in combination, rice flour, potato flour, buckwheat flour, spelt flour, corn flour or other low fructans flour products. Added whole grains can include quinoa. oats and seeds. The addition of gluten (as a flour) allows the resulting dough products made from the flour mix to act more like wheat based flours during cooking or baking, than currently available gluten free flours. The resulting low fructans product is a medicament useful in the management of irritable bowel syndrome. as individuals are thought to react to the fructans (carbohydrate) component of wheat, barley, and rye, not the protein gluten content. Therefore a product than contains gluten to provide elasticity and crustiness is more palatable than a product devoid of gluten, and not consumed by choice, but only consumed because it is also low in fructans.

The combining of gluten (or gluten flour) with low fructan ground grains (or low fructan flours) ensures that the resultant new product is suitable for people suffering from IBS and others who wish to reduce the fructans content of their diet. The nutrient composition of the flour will usually be similar to regular bread, pasta and other products. For example, the protein content of the flour will be 6-8% for the purpose of baking cakes, approximately 10% for making pasta and up to 16% for making bread.

For the avoidance of doubt, the term “wheat” as used herein refers to conventional wheat and does not include buckwheat or spelt. Both buckwheat and spelt are low in fructans.

### Example 1

### Bread

A dough was prepared from the following ingredients:

600 g white or brown rice flour

200 g potato flour

100 g buckwheat flour

100 g wheat free corn (i.e. maize) flour

to which was added 4 tablespoons (approximately 60 g) of gluten flour, and sufficient water to form a dough of medium consistency. The ingredients were mixed and kneaded until the dough was formed. The formed dough was then placed in a bread tray and baked for 25 minutes in a medium oven. The resulting bread had a thin but crisp crust and the texture of the bread was soft but resilient.

### Example 2

### Bread

1 cup fine oatmeal

1¼ cups rice flour

¾ cup gluten flour (80% protein)

1½ teaspoon salt,

1½ tablespoon sugar,

1½ teaspoon yeast,

1 teaspoon bread improver

350 ml water

The ingredients were added to a breadmaking machine, water first, followed by the dry ingredients. The breadmaking machine was set for a medium loaf and the resulting bread was of a consistency similar to wholemeal wheat bread.

### Example 3

### Pasta Dough

100 g brown rice flour

100 g all purpose (plain) gluten tree flour

100 g cup gluten flour

generous pinch of sea salt

3 eggs

1 tablespoon water or olive oil

All the flour was placed in a large mixing bowl, with a well in the centre. The eggs were cracked, into the well, and then beaten with a fork until smooth. The eggs were then gradually mixed into the flour, until combined, eventually forming one smooth piece of dough. Water or oil was added to achieve a smooth dough if the dough was still too dry.

The dough was worked to develop the gluten in the flour until the pasta started to feel smooth and silky. The pasta dough was wrapped in ding film and put it in the fridge to rest for at least half an hour before being rolled and cut to make pasta.

### Example 4

### Crunchy Bread

200 g brown rice flour

100 g buckwheat flour

75 g spelt

100 g of LSA (combined linseed, sunflower and almond meal) or Psyllium

125 g vital wheat gluten

25 g bread improver

25 g milk powder

7 g yeast

10 g salt

420 g water

The dry ingredients were mixed together and the water added slowly to form a dough of medium consistency. The dough was allowed to stand at room temperature for 30 minutes in a loaf baking tray to allow the dough to rise. After the dough had risen, it was baked in a medium oven for 20 minutes. The interior of the bread was soft and elastic and the bread had a thin but crisp crust.

Using the above-mentioned bread of Example 4, a trial was conducted on 20 volunteers each of whom suffered from the symptoms of IBS. With two exceptions, all volunteers found they could consume upto 6 slices of bread per day without any adverse symptoms appearing. That is, 18 volunteers remained asymptomatic. The two volunteers who had symptoms all had symptoms occurring contemporaneously with a stress event in their life during the trial and had previously been asymptomatic prior to the occurrence of the stress event, or had reported non-compliance with a low FODMAPs/FOLFAPs diet at the time of symptoms.

Accordingly, the trial provides an excellent indication that the symptoms of TBS can be ameliorated in accordance with the teachings of the present invention.

The foregoing describes only some embodiments of the present invention and modifications, obvious to those skilled in the dietary arts, can be made thereto without departing from the scope of the present invention.

The term “comprising” (and its grammatical variations) as used herein is used in the inclusive sense of “including” or “having” and not in the exclusive sense of “consisting only of”.

1. (canceled)

2. (canceled)

3. (canceled)

4. (canceled)

5. (canceled)

6. A medicament for treating irritable bowel syndrome, said medicament comprising a gluten content of between 5% and 35% by weight in a low fructan flour based product.

7. The medicament as claimed in claim 6 wherein the gluten content of said flour is between approximately 10% and approximately 30% by weight.

8. The medicament as claimed in claim 6 wherein said low fructan flour is selected from the class consisting of rice flour, potato flour, buckwheat flour, spelt flour, tapioca flour, millet flour, oat flour, quinoa flour, and cornflour.

9. A method of treating the symptoms of irritable bowel syndrome comprising the steps of substantially simultaneously reducing the intake of fructans or FODMAPS or FOLFAPs, and increasing the intake of gluten.

10. The method as claimed in claim 9 comprising the step of ingesting a medicament comprising a gluten content of between 5% and 35% by weight in a low fructan flour based product.

11. A method of treating, alleviating, or preventing, symptoms associated with irritable bowel syndrome in a person in need of treatment therefor, the method comprising the steps of providing food to said person wherein said food includes flour comprising a mixture of one or more low fructan flours and gluten or gluten flour such that said flour mixture substantially excludes wheat flour, barley flour and rye flour.

12. The method as claimed in claim 11 wherein the gluten content of said flour mixture is between approximately 5% and approximately 35% by weight.

13. The method as claimed in claim 12 wherein the gluten content of said flour is between approximately 10% and approximately 30% by weight.

14. A method of improving the palatability of a low fructan food product without increasing the fructan content of said low fructan food product, said method comprising the step of increasing the gluten content of said product.

15. The method as claimed in claim 14 wherein said low fructan food product is made from low fructan flour and the gluten content of said flour is between approximately 5% and approximately 35% by weight.

16. The method as claimed in claim 15 wherein the gluten content of said flour is between approximately 10% and approximately 30% by weight.

17. The method as claimed in claim 15 wherein said low fructan flour is selected from the class consisting of rice flour, potato flour, buckwheat flour, spelt flour, tapioca flour, millet flour, oat flour, quinoa flour, and cornflour.

18. A flour comprising a mixture of one or more low fructan flours, and gluten or gluten flour wherein said flour mixture substantially excludes wheat flour, barley flour, and rye flour, said flour mixture being used in the manufacture of a medicament for use in treating, alleviating, or preventing, symptoms associated with irritable bowel syndrome.

19. The flour as claimed in claim 18 wherein the medicament is a low fructan flour or a low fructan flour based product.

20. The flour as claimed in claim 19 wherein the gluten content of said flour is between approximately 5% and approximately 35% by weight.

21. The flour as claimed in claim 20 wherein the gluten content of said flour is between approximately 10% and approximately 30% by weight.

22. The flour as claimed in claim 18 wherein said flour is selected from the class consisting of rice flour, potato flour, buckwheat flour, spelt flour, tapioca flour, millet flour, oat flour, quinoa flour, and cornflour.

23. The flour as claimed in claim 18 wherein the gluten or gluten flour includes the proteins gliadin and glutenins.

24. A dough made from the flour as claimed in claim 18 by the addition of a liquid thereto.

25. The dough as claimed in claim 24 wherein said liquid comprises water or raw beaten egg.

26. A baked, boiled, or otherwise cooked product prepared from the dough as claimed in claim 24.

27. A pasta product made from dough as claimed in claim 11.
